(19) United States
(12) Patent Application Publication
(10) Pub. No.: US 2017/0015239 A1
(43) Pub. Date: Jan. 19, 2017

(54) SYSTEM AND METHOD FOR NO-TURN-ON-RED REMINDER

(71) Applicant: FORD GLOBAL TECHNOLOGIES, LLC, Dearborn, MI (US)

(72) Inventors: Manoharprasad K. RAO, Novi, MI (US); Kwaku O. PRAKAH-ASANTE, Commerce Twp., MI (US)

(21) Appl. No.: 14/797,569

(22) Filed: Jul. 13, 2015

(51) Int. Cl. B60Q 9/00; G08G 1/0967; G01C 21/36; G01C 21/26; B60Q 1/34

(52) U.S. Cl. CPC B60Q 9/00; G01C 21/26; B60Q 1/34; G01C 21/3697; G08G 1/0967

(57) ABSTRACT

A vehicle includes a navigation system configured to output a vehicle location and an intersection location at which a turn on red is prohibited. The vehicle includes a controller programmed to, in response to the vehicle location being in proximity to the intersection location and data being indicative of a driver intention to turn at the intersection, output an indicator to inform a driver that the turn on red is prohibited.

### TECHNICAL FIELD

The application generally relates to an alert for a driver of a vehicle when right turns on red lights are prohibited at an intersection.

### BACKGROUND

A common traffic law in many areas is a regulation that permits initiating a turn on a red light at intersections. For example, in some countries that drive on the right side of the roadway, a right turn on red is permitted. However, conditions at some intersections may make it impractical to permit turns on red. Factors such as traffic density and visibility may be analyzed in deciding to prohibit turns on red at an intersection. Signs are placed at the affected intersections to provide notice to drivers that turns on red are prohibited at the intersection.

### SUMMARY

A vehicle includes a navigation system configured to output a vehicle location and an intersection location at which a turn on red is prohibited. The vehicle further includes at least one controller programmed to, in response to the vehicle location being in proximity to the intersection location and the vehicle location being indicative of the vehicle being in a turn lane for the intersection, output a signal to activate an indicator that the turn on red is prohibited.

The vehicle may include a turn indicator system configured to output a turn signal indicator. The at least one controller may be further programmed to output the signal in response to the vehicle location being in proximity to the intersection location and the turn signal indicator being activated.

The at least one controller may be further programmed to output the signal in response to the vehicle location being in proximity to the intersection location and a speed of the vehicle being less than a predetermined speed.

The navigation system may be further configured to output a planned route for the vehicle. The at least one controller may be further programmed to output the signal in response to the vehicle location being in proximity to the intersection location and the planned route including a turn at the intersection.

The vehicle may further include a display panel and the indicator may be displayed on the display panel. The vehicle may further include an audible alert device and the indicator may be generated by the audible alert device.

The navigation system may be further configured to output a time range for which the turn on red at the intersection is prohibited. The at least one controller may be further programmed to inhibit output of the signal based on a present time being outside of the time range.

In some configurations, the at least one controller is programmed to, in response to the vehicle location being in proximity to the intersection location and data being indicative of an imminent turn at the intersection, output a signal to activate an indicator that the turn on red is prohibited. The data may include the turn signal indicator being activated. The data may include a speed of the vehicle being less than a predetermined speed. The data may include a vehicle location being located in a turn lane for the intersection. The data may include the planned route of the vehicle including a turn at the intersection.

A method includes outputting, by a controller, a notification that a turn on red is prohibited in response to a vehicle location being in proximity to an intersection location at which turns on red are prohibited and data being indicative of an intention to turn at the intersection. The method further includes displaying the notification to a driver. The method may further include outputting the notification in response to a current time being within a time range for which turns on red are prohibited at the intersection location.

The vehicle location may be in proximity to the intersection location when the vehicle location is less than a predetermined distance from the intersection location. The vehicle location may be in proximity to the intersection location when a time to arrival to the intersection location is less than a predetermined time.

### BRIEF DESCRIPTION OF THE DRAWINGS

FIG. 1 is an example of a vehicle including modules for a no-turn-on-red (NTR) reminder system.

FIG. 2 is a flowchart for possible operations for implementing a NTR reminder system.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

A common traffic rule enacted by most jurisdictions in the United States is the rule that permits a driver to turn right during a red light. A driver may turn right on a red light when there is no approaching traffic in the roadway to which the right turn is being made. At some intersections, busy traffic conditions may persist or visibility may be obstructed or impaired. At these intersections, a jurisdiction may decide that right turns on red are prohibited. At some intersections, the prohibition against right turns on red may be limited to a certain time range. At intersections for which a turn on red is prohibited, a sign may be placed that indicates to drivers that turns on red are prohibited and any associated time restrictions.

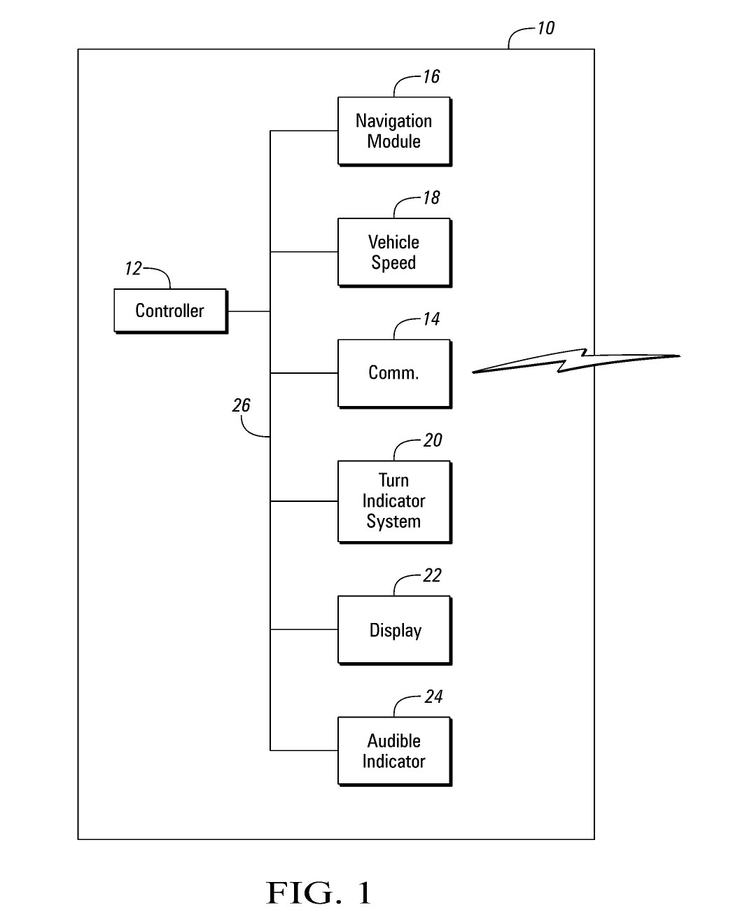

For many reasons, a driver may fail to recognize the sign indicating that turns on red are prohibited. The failure to recognize the sign could lead to the driver making a prohibited turn—leading to a traffic violation or an accident. Such issues may be prevented by implementation of a no-turn-on-red (NTR) reminder system. FIG. 1 depicts an example of a vehicle 10 and associated modules that may be included in a NTR reminder system.

Electronic modules in the vehicle 10 may communicate via one or more vehicle networks 26. The vehicle network 26 may include a plurality of channels for communication. One channel of the vehicle network 26 may be a serial bus such as a Controller Area Network (CAN). One of the channels of the vehicle network 26 may include an Ethernet network defined by Institute of Electrical and Electronics Engineers (IEEE) 802 family of standards. Additional channels of the vehicle network 26 may include discrete connections between modules and may include power signals from a battery. Different signals may be transferred over different channels of the vehicle network 26. For example, video signals may be transferred over a high-speed channel (e.g., Ethernet) while control signals may be transferred over CAN or discrete signals. The vehicle network 26 may include any hardware and software components that aid in transferring signals and data between modules. At least one controller 12 may be present to coordinate the operation of the various components and modules. The controller 12 may include a processor along with volatile and non-volatile memory for storing instructions and data.

The vehicle 10 may include a wireless communications module 14 to communicate with devices and systems remote from the vehicle 10. The wireless communications module 14 may include an onboard modem having an antenna to communicate with off-board devices or systems. The wireless communications module 14 may be a cellular communications device to enable communications via a cellular data network. The wireless communications module 14 may be a wireless local area network (LAN) device compatible with IEEE 802.11 family of standards (i.e., WiFi) or a WiMax network. The wireless communications module 14 may include a vehicle based wireless router to allow connection to remote networks in range of a local router. The wireless communications module 14 may interface with one or more controllers 12 via the vehicle network 26 to send and receive data.

The vehicle 10 may include a navigation system 16 that is configured to provide routing information to the driver. The navigation system 16 may include a vehicle position sensor that is compatible with the Global Positioning System (GPS). The navigation system 16 may include a display for displaying map and route information. The display may be a touchscreen that is used for providing input to the navigation system 16. The operator may input a destination or select a destination from memory. In some modes of operation, the navigation system 16 may track the vehicle location and display a symbol representing the vehicle on a map. The navigation system 16 may output vehicle position and routing data to other electronic modules. The navigation system 16 may output a direction of travel of the vehicle 10.

The navigation system 16 may be configured to output intersection data that indicates intersections at which turns on red are prohibited. The navigation system 16 may include an associated database that includes the intersection data. In some configurations, the database may be external to the navigation system 16 and accessed via a wireless communication module 14. The intersection data may include one or more directions from which the intersection may be approached. For example, an intersection may be approached from directions of north, south, east, and west and turns on red may only be prohibited when approached from the south (heading north at the intersection). The intersection data may include a number of lanes in each direction and a number of turn lanes for each direction. To enhance lane detection, the navigation system 16 may be configured to output vehicle position data with sufficient resolution that a lane in which the vehicle is traveling may be ascertained. The database may include position data for lanes at the intersection that may be compared to the vehicle location data. The vehicle location data may be communicated to the controller via the vehicle network 26.

The navigation system 16 may update and output the vehicle position and direction of travel at a predetermined rate. Based on the vehicle position and direction of travel, the navigation system 16 may retrieve position and/or coordinates of upcoming intersections from the database. The position or coordinates of intersections that are near the vehicle position may be derived from the database. The intersection may be identified as an intersection at which turns on red are prohibited. When the vehicle 10 is in proximity to an intersection at which turns on red are prohibited, an indication may be provided to the driver. Intersection data may be communicated to the controller 12 via the vehicle network 26.

The vehicle 10 may include a vehicle speed subsystem 18. The vehicle speed subsystem 18 may provide a signal indicative of the speed that the vehicle is traveling. For example, the vehicle speed subsystem 18 may derive a vehicle speed from wheel speed sensors or transmission speed sensors. The vehicle speed subsystem 18 may derive the vehicle speed from vehicle position data output from the navigation system 16. Vehicle speed may be communicated to the controller 12 over the vehicle network 26.

The vehicle 10 may include a turn indicator system 20. The turn indicator system 20 may include a lever for activating signaling of a turn. The turn indicator system 20 may include lamps on the front and rear of the vehicle for signaling the turn to other vehicles. For example, a lever may be mounted on a steering wheel column and capable of moving to an upward or a downward position. The upward position may cause activation of lamps on a passenger side of the vehicle to indicate a right turn. The downward position may cause activation of lamps on a driver side of the vehicle to indicate a left turn. The lever position may cause the activated lamps to blink at a predetermined frequency. Additional lamps or indicators may be displayed within the vehicle 10 to inform the driver of the signaling action. Signals from the lever and/or the lamps may be received by the controller 12 to provide status of the turn indicator system 20. From the signals, the controller 12 may determine a driver intention to turn and an expected direction of the turn.

The vehicle 10 may include one or more indicators configured to convey status information to the driver. At least one indicator may be configured as a reminder that turns on red are prohibited at the intersection at which the vehicle is in proximity to. The indicator may be referred to as a NTR reminder. The NTR reminder may be included within one or more display panels 22. The display panels 22 may include lamps to indicate status. In some configurations, the display panels 22 may include a graphical display capable of indicating status graphically or textually. The display panels 22 may activate a lamp or display a message that indicates that turns on red are prohibited at an approaching intersection. In some configurations, the display panels 22 may include a heads-up display that projects the NTR reminder onto a windshield. The vehicle 10 may include an audible indicator 24 configured to convey the NTR reminder using a sound. The audible indicator 24 may be a buzzer, bell, or electronic sound generator. In some configurations, the audible indicator 24 may be included as a function of an audio system that plays a tone or voice message to indicate the condition.

In some configurations, the NTR reminder may be incorporated with a turn signal indicator that is visible to the driver. The turn signal indicator may change color in response to turns on red being prohibited. For example, the turn signal indicator may normally flash a green light or arrow visible to the driver when the turn signal is activated. When turns on red are prohibited, the turn signal indicator may flash a red light or arrow to the driver.

In some configurations, the controller 12 may generate the NTR reminder when the vehicle position is less than a predetermined distance from the intersection at which turns on red are prohibited. The distance to the intersection may be derived from the vehicle position and the intersection location. In some configurations, the controller 12 may generate the alert signal when an arrival time to the intersection is less than a predetermined time. The arrival time may be derived from the distance to the intersection and the vehicle speed. The NTR reminder may trigger the display panels 22 to provide the NTR reminder to the driver.

It may be distracting to the driver to always display the NTR status for the upcoming intersection. For example, the vehicle 10 may be approaching an intersection at which turns on red are prohibited, but the driver has no intention of turning. In some configurations, it may be desired to display the indication only when driver intends to turn on at the intersection. The controller 12 may process various signals to determine the driver intent to turn.

The NTR reminder system may include a driver interface subsystem that configures the NTR reminder system based on driver preferences. The NTR reminder system may be configurable to provide an individualized reminder to each driver of the vehicle 10. Alert sequences may be based on selected preferences of the driver. Selection options may include the means of notification and the distance or time to the intersection at which to generate the notification. In the absence of selected preferences, a set of default preferences may be provided. For example, the driver interface subsystem may be incorporated as part of the navigation system 16 using the display/touchscreen to interface with the driver.

The controller 12 may implement instructions to determine the proximity of the vehicle 10 to a NTR intersection. The controller 12 may receive the vehicle location data, route information, and the intersection location data from the navigation system 16. The intersection data may include location information for upcoming or nearby intersections through which the vehicle 10 may travel. Associated with each intersection may be an indication that turns on red are prohibited at the intersection. Intersections at which turns on red are prohibited may be referred to as NTR intersections. The controller 12 may compute the proximity of the vehicle 10 to the NTR intersection. A distance from the vehicle 10 to the NTR intersection may be computed. Using vehicle speed and the distance, a time of arrival at the NTR intersection may be computed as the quotient of the distance divided by the vehicle speed. The controller may produce a signal indicative of the vehicle 10 being in proximity to the NTR intersection.

The controller 12 may implement instructions to determine the intent of the driver to initiate a turn at an intersection. Vehicle location data and intersection data may be processed to determine if the vehicle 10 is traveling in a turn lane near an intersection. Driver intent to turn may be inferred if the vehicle 10 is traveling in a turn lane near the intersection. The turn lane may include turn only lanes in which the vehicle in the turn only lane is normally required to turn at the intersection. The turn lane may include any lanes from which the vehicle may legally complete the turn. The turn lanes may be marked with signs at the intersection or arrows painted in the lanes of the roadway. In a configuration that monitors for right turns, the turn lanes may include those lanes from which the right turn may be initiated.

On some roadways, there may be more than one lane of traffic in the direction of travel. In these situations, the indication may only be appropriate when the vehicle 10 is in the turn lane. The following examples are based on a right turn on red as is common in the United States. In other countries, it may be left turn on red that is applicable. For example, when there are two lanes of traffic in the same direction, the indication may only be useful when the vehicle 10 is in the rightmost lane. The reasoning being that the right turn may normally only be contemplated when the driver is in the rightmost lane. If the vehicle 10 is in the leftmost lane, conditions would not be indicative of the driver intent to make a right turn.

One condition for inferring the driver intent may be that the vehicle 10 is in a lane that includes an option to turn in the prohibited direction. The condition may include that the vehicle 10 is in the rightmost lane of the roadway. At some intersections, more than one lane may be permitted to turn. Intersection data may include the number of turn lanes that are available at the associated intersection. At some intersections, turns on red may be prohibited only from some of the turn lanes. For example, turns on red may be allowed from a rightmost lane but not from other turn lanes. The database of the navigation system 16 may include the location of intersections at which turns on red are presently prohibited. The database may include for each intersection the number of lanes that are permitted to turn onto an intersecting roadway. The vehicle position at the intersection may be determined and compared to lane position data to determine if the vehicle 10 is in one of the turn lanes.

The vehicle 10 may include one or more camera systems configured to detect a position of the vehicle 10 within the roadway. The camera may be part of a lane departure warning system. The system may be capable of detecting a lane of travel for the vehicle and may be capable of identifying additional lanes. The system may provide information at to which lane the vehicle 10 is presently traveling in.

Vehicle speed and braking system signals may also be indicative of an intention to turn. For example, actuation of the braking system and a decrease in vehicle speed when approaching the intersection may be indicative of an intention to turn. The vehicle 10 may include a collision warning system or adaptive cruise control system that incorporates a radar system. Signals from the radar system may provide information about other vehicles that are in the path of the vehicle 10 that may be causes of speed decreases. The driver intent to turn may be conditioned on the vehicle speed being less than a predetermined speed.

The controller 12 may monitor turn indicator signals to determine the driver intent. Activation of the turn indicators may indicate the driver intent to turn at an intersection. For example, activation of the right turn signal may provide a strong indication of the driver intent to turn in the NTR direction.

The vehicle 10 may include a time-of-day module that outputs a present date and time to the controller 12. The controller 12 may receive the present date and time information periodically. The date and time information may be compared to the time information associated with the turn on red data for the intersection to determine if the turn on red is prohibited at the present time. If the time information is within a range of dates and times in which turns on red are prohibited, then the NTR reminder may be provided to the driver.

The controller 12 may be configured to output the NTR reminder signal to the display interface. The controller 12 may determine that the vehicle 10 is in proximity with the NTR intersection and that the driver intends to turn in the NTR direction. In response, the notification subsystem may generate an NTR reminder request based on the configuration defined by the driver interface subsystem.

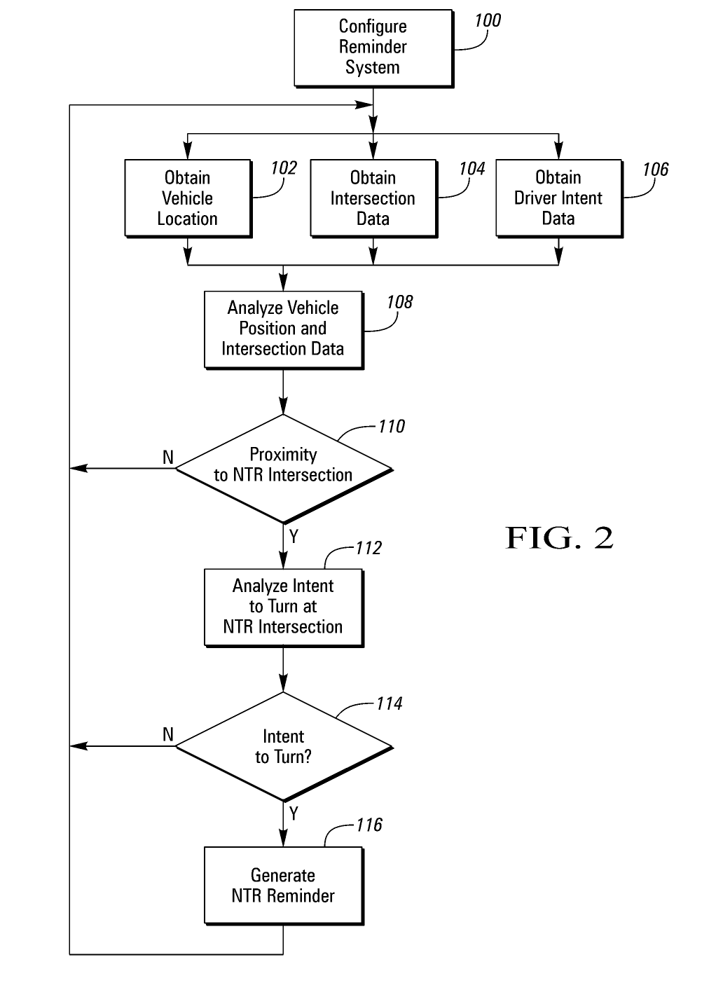

FIG. 2 depicts a flow chart of a possible sequence of operations to implement the NTR reminder system. The controller 12 may store and execute instructions to implement the NTR reminder system. Operation 100 may be executed to configure the reminder system for usage. Instructions may be executed to tailor the NTR reminder system based on preferences of the driver. Input may be via touchscreen interface or an external application executed on a remote device that communicates via the wireless communication module 14.

Operation 102 may be executed to obtain the vehicle location. The navigation system 16 may process GPS signals to compute the present location and heading of the vehicle 10. The vehicle location data may be output to the controller 12 and other modules.

Operation 104 may be executed to obtain intersection data. The navigation system 16 may retrieve intersection data from the database that is on a present route or within a predetermined distance of the present vehicle location. The intersection data may include a status regarding prohibition of turns on red at the intersection, the number of turn lanes at the intersection, and location or coordinates of the turn lanes. The intersection data may be output to the controller 12 and other modules.

Operation 106 may be executed to obtain driver intent data. The controller 12 may implement instructions to sample signals or receive signals from the vehicle network 26. The various signals may be analyzed to determine if the driver intends to turn in the prohibited direction at the intersection. For example, signals from the turn indicator system 20 may be sampled and processed.

Operation 108 may be executed to analyze the vehicle position and intersection data. The vehicle position may be compared to the intersection location to determine if the vehicle is in proximity to the NTR intersection. Proximity to the NTR intersection may be based on the distance to the NTR intersection and/or the arrival time to the NTR intersection.

Decision block 110 may be executed to check if the vehicle is in proximity to the NTR intersection. The vehicle 10 may be in proximity to the NTR intersection when the vehicle position is within a predetermined distance of the NTR intersection. The vehicle 10 may be in proximity to the NTR intersection when the arrival time to the NTR intersection is less than a predetermined time. If the vehicle 10 is not in proximity to the NTR intersection, then execution may loop back to operations 102-106 and the process repeated. If the vehicle 10 is in proximity to the NTR intersection, then execution may proceed to operation 112.

Operation 112 may be executed to analyze the driver intent to turn at the NTR intersection. Various conditions may be considered to infer the driver intent as discussed previously. For example, the driver intent to turn may be inferred by the activation of a turn signal indicator or by being in a turn lane for the intersection. Map data may be analyzed to determine lanes from which a turn is permitted. Vehicle position data may be monitored to determine if the vehicle is in a lane in which the turn is permitted. Further, signals from the turn indicator system 20 may be monitored to determine if the driver has signaled an intention to turn in the prohibited direction. Route information may be analyzed to determine if the planned route includes a turn at the intersection.

Decision block 114 may be executed to check if the conditions to infer an intention to turn at the NTR intersection are satisfied. If no intent to turn is suspected, the NTR reminder may be inhibited and not displayed to the driver. Execution may loop back to operations 102-106 and the process repeated. If an intention to turn is detected, operation 116 may be executed to generate the NTR reminder. The NTR reminder may be issued to the driver in the manner configured.

The NTR reminder system aids the driver to prevent turning on red at intersections at which such turns are prohibited. The system alerts the driver and may prevent the driver from making a prohibited turn. The system enables the driver to focus on driving instead of searching for road signs at the intersection. The NTR reminder is in a consistent location and may be displayed in the event a road sign is damaged or missing. Further, the NTR reminder system may be configured to alert the driver based on the driver intent to make a turn in the NTR direction. By inhibiting NTR alerts based on the driver intent, the driver is not distracted by unnecessary alerts at every NTR intersection.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
a navigation system configured to output a vehicle location and an intersection location at which a turn on red is prohibited; and
at least one controller programmed to, in response to the vehicle location being in proximity to the intersection location and the vehicle location being indicative of the vehicle being in a turn lane for the intersection, output a signal to activate an indicator that the turn on red is prohibited.

2. The vehicle of claim 1 further comprising a turn indicator system configured to output a turn signal indicator, and wherein the at least one controller is further programmed to output the signal in response to the vehicle location being in proximity to the intersection location and the turn signal indicator being activated.

3. The vehicle of claim 1 wherein the at least one controller is further programmed to output the signal in response to the vehicle location being in proximity to the intersection location and a speed of the vehicle being less than a predetermined speed.

4. The vehicle of claim 1 wherein the vehicle location is in proximity to the intersection location when the vehicle location is less than a predetermined distance from the intersection location.

5. The vehicle of claim 1 wherein the vehicle location is in proximity to the intersection location when a time to arrival to the intersection location is less than a predetermined time.

6. The vehicle of claim 1 wherein the navigation system is further configured to output a planned route for the vehicle, and wherein the at least one controller is further programmed to output the signal in response to the vehicle location being in proximity to the intersection location and the planned route including a turn at the intersection.

7. The vehicle of claim 1 further comprising a display panel and wherein the indicator is displayed on the display panel.

8. The vehicle of claim 1 further comprising an audible alert device and wherein the indicator is generated by the audible alert device.

9. The vehicle of claim 1 wherein the navigation system is further configured to output a time range for which the turn on red at the intersection is prohibited, and wherein the at least one controller is further programmed to inhibit output of the signal based on a present time being outside of the time range.

10. A vehicle comprising:
a navigation system configured to output a vehicle location and an intersection location at which a turn on red is prohibited; and
at least one controller programmed to, in response to the vehicle location being in proximity to the intersection location and data being indicative of an imminent turn at the intersection, output a signal to activate an indicator that the turn on red is prohibited.

11. The vehicle of claim 10 further comprising a turn indicator system configured to output a turn signal indicator, wherein the data includes the turn signal indicator being activated.

12. The vehicle of claim 10 wherein the data includes a speed of the vehicle being less than a predetermined speed.

13. The vehicle of claim 10 wherein the data includes a vehicle location being located in a turn lane for the intersection.

14. The vehicle of claim 10 wherein the vehicle location is in proximity to the intersection location when the vehicle location is less than a predetermined distance from the intersection location.

15. The vehicle of claim 10 wherein the vehicle location is in proximity to the intersection location when a time to arrival to the intersection location is less than a predetermined time.

16. The vehicle of claim 10 wherein the navigation system is further configured to output a planned route for the vehicle and the data includes the planned route of the vehicle including a turn at the intersection.

17. A method comprising:
outputting, by a controller, a notification that a turn on red is prohibited in response to a vehicle location being in proximity to an intersection location at which turns on red are prohibited and data being indicative of an intention to turn at the intersection; and
displaying the notification to a driver.

18. The method of claim 17 wherein the data includes one or more of a vehicle speed being less than a predetermined speed, a turn signal indicator being activated, and a vehicle location being within a turn lane for the intersection.

19. The method of claim 17 wherein the vehicle location being in proximity to the intersection includes one or more of the vehicle location being less than a predetermined distance from the intersection location and an arrival time to the intersection location being less than a predetermined time.

20. The method of claim 17 further comprising outputting the notification in response to a current time being within a time range for which turns on red are prohibited at the intersection location.
